(19) United States
(12) Patent Application Publication
(10) Pub. No.: US 2019/0184766 A1
(43) Pub. Date: Jun. 20, 2019

(54) PNEUMATIC TIRE WITH A ROBUST BEAD AREA STRUCTURE

(71) Applicant: The Goodyear Tire & Rubber Company, Akron, OH (US)

(72) Inventors: Jean-Julien Edouard Ghislain Krier, Bastogne (BE); Bernard D'Hamers, Colmar-Berg (LU); Peter Johann Cornelius Maus, Bullingen (BE); Hao Zhang, Ettelbruck (LU); Xiaofeng Song, Dalian (CN)

(21) Appl. No.: 16/116,180

(22) Filed: Aug. 29, 2018

Related U.S. Application Data
(60) Provisional application No. 62/599,354, filed on Dec. 15, 2017.

(51) Int. Cl. B60C 15/06

(52) U.S. Cl. CPC B60C 15/0635; B60C 2015/0685; B60C 2015/0692; B60C 2200/06

(57) ABSTRACT

A pneumatic radial tire includes a pair of opposing bead areas, in which each bead area includes a bead core and a bead apex. At least one carcass reinforcing ply includes a turn up at each bead core, and each turn up includes a radially outward end. A pair of chippers is disposed axially inwardly of each turn up outward end, in which the pair of chippers includes a first chipper and a second chipper. The first chipper is disposed axially inwardly of the bead apex, and the second chipper is disposed axially outwardly of the first chipper and axially inwardly of the bead apex. Forces due to deflection of the tire are limited by the pair of chippers to reduce stresses along each turn up.

### FIELD OF THE INVENTION

The invention relates to pneumatic tires. More particularly, the invention relates to the structure of radial ply tires. Specifically, the invention is directed to a pneumatic radial tire that includes a structure which improves the durability of the bead area of the tire.

### BACKGROUND OF THE INVENTION

In the manufacture of a pneumatic tire, the tire is typically built on the drum of a tire-building machine, which is known in the art as a tire building drum. Numerous tire components are wrapped about and/or applied to the drum in sequence, forming a cylindrical-shaped tire carcass. The tire carcass is then expanded into a toroidal shape for receipt of the remaining components of the tire, such as a belt package and a rubber tread. The completed toroidally-shaped unvulcanized tire carcass, which is known in the art at that stage as a green tire, is then inserted into a mold or press for forming of the tread pattern and curing or vulcanization.

One of the components of the tire is the bead area. The bead area includes a core, which is an annular tensile member wrapped by ply cords and shaped to fit the wheel rim. Typically, a bead core is integrated into each side of the tire to provide a secure fit of the tire on each side of the wheel rim.

Durability of the bead area of the tire is an item that is sought to be improved in the tire industry. For example, in applications such as short distance delivery in city or urban environments, the frequent starting and stopping of a vehicle such as a truck may create high load conditions on the bead area of the tire.

A tire of the prior art is shown in FIGS. 1 and 2 and indicated at 10. The tire 10 includes a pair of bead areas 12 and a respective bead core 14 embedded in each bead area. A respective sidewall 16 extends radially outward from each bead area 12 to a ground-contacting tread 18. The tire 10 is reinforced by a carcass 20 that toroidally extends from one of the bead areas 12 to the other one of the bead areas. The carcass 20 includes at least one ply 22 that preferably winds around each bead core 14. A belt reinforcement package 24 is disposed between the carcass 20 and the tread 18.

What is conventionally considered a main portion 26 of the carcass reinforcing ply 22 extends radially inward toward the tire rim (not shown) and is turned about each bead core 14 to form a carcass ply turn up 28. The carcass ply turn up 28 extends at a single angle μ relative to a radial line tangent to the axially outermost point of the bead core 14 and parallel to the equatorial plane of the tire 10. A chafer 30 is disposed about the radially inward surface of the carcass ply turn up 28 to resist chafing of the tire 10 by the rim.

Due to the configuration and nature of the radial carcass 20, when the tire 10 is expanded, the main portion 26 of the carcass ply 22 is put under tension, pulling the carcass main portion radially outward and the carcass ply turn up 28 radially inward. After inflation and during operation of the tire 10, when the tire is under deflection, the carcass ply 22 is subject to bending forces and the carcass main portion 26 moves radially inward while the carcass turn up 28 moves radially and axially outward. Due to the adhesion relationship between the rubber and the reinforcing cords of the ply 22, the rubber surrounding the carcass main portion 26 and the carcass turn up 28 also is forced to move during both tension and deflection, resulting in the rubber being stressed. The movement of the carcass ply 22 and the surrounding rubber may thus result in cracking of the rubber in each tire bead area 12, thereby potentially decreasing durability of the tire 10.

Therefore, it is desirable to provide a tire that includes a structure that improves the durability of the bead area.

### SUMMARY OF THE INVENTION

According to an aspect of an exemplary embodiment of the invention, a pneumatic radial tire includes a pair of opposing bead areas, in which each bead area includes a bead core and a bead apex. At least one carcass reinforcing ply includes a turn up at each bead core, and each turn up includes a radially outward end. A pair of chippers is disposed axially inwardly of each turn up outward end, in which the pair of chippers includes a first chipper and a second chipper. The first chipper is disposed axially inwardly of the bead apex, and the second chipper is disposed axially outwardly of the first chipper and axially inwardly of the bead apex. Forces due to deflection of the tire are limited by the pair of chippers to reduce stresses along each turn up.

### Definitions

“Axial” and “axially” mean lines or directions that are parallel to the axis of rotation of the tire.

“Axially inward” and “axially inwardly” refer to an axial direction that is toward the equatorial plane of the tire.

“Axially outward” and “axially outwardly” refer to an axial direction that is away from the equatorial plane of the tire.

“Bead” means that part of the tire comprising an annular tensile member wrapped by ply cords and shaped, with or without other reinforcement elements such as flippers, chippers, apexes, toe guards and chafers, to fit the design rim.

“Carcass” means the tire structure apart from the belt structure, tread, undertread, and sidewall rubber over the plies, but including the beads.

“Chafer” means a layer of reinforcing material around the bead in the rim flange area to prevent chafing of the tire by the rim.

“Chipper” means a band of fabric or steelcord located in the bead area with the function of reinforcing the bead area and stabilizing the lower sidewall of the tire.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Inboard” and “inboardly” refer to an axial direction that is toward the equatorial plane of the tire.

“Innerliner” means the layer or layers of elastomer or other material that form the inside surface of a tubeless tire and that contain the inflating fluid within the tire.

“Outboard” and “outboardly” refer to an axial direction that is away from the equatorial plane of the tire.

“Radial” and “radially” mean lines or directions that are perpendicular to the axis of rotation of the tire.

“Radially inward” and “radially inwardly” refer to a radial direction that is toward the central axis of rotation of the tire.

“Radially outward” and “radially outwardly” refer to a radial direction that is away from the central axis of rotation of the tire.

“Radial-ply tire” means a belted or circumferentially-restricted pneumatic tire in which the ply cords which extend from bead to bead are laid at cord angles between about 65 to about 90 degrees with respect to the equatorial plane of the tire.

### BRIEF DESCRIPTION OF THE DRAWINGS

The invention will be described by way of example and with reference to the accompanying drawings, in which:

FIG. 1 is a schematic cross-sectional view of an exemplary tire of the prior art;

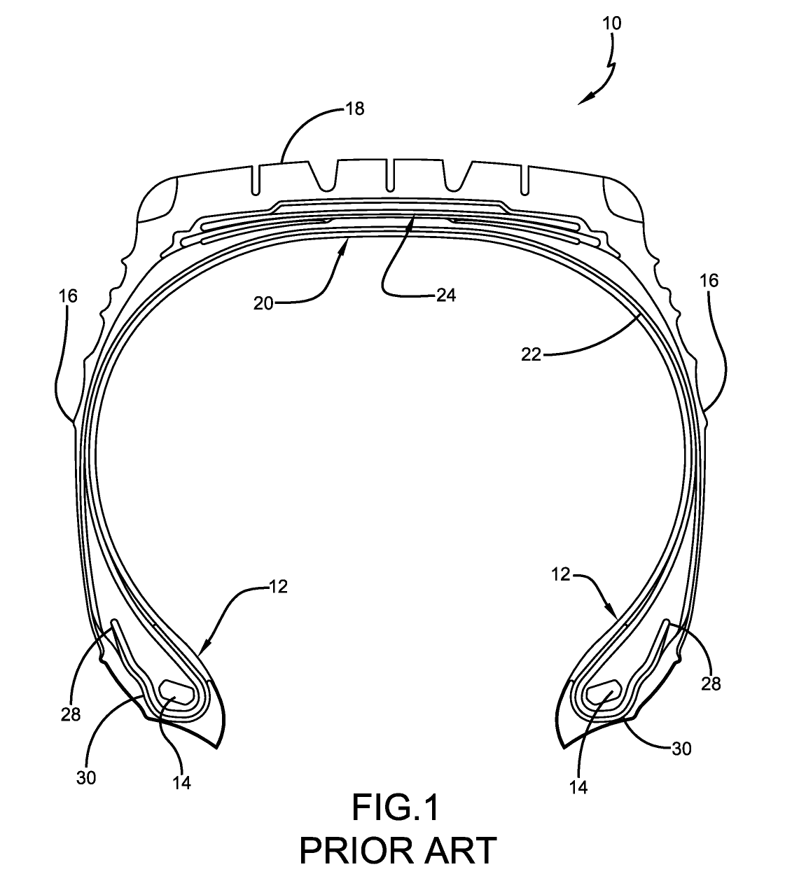

FIG. 2 is an enlarged fragmentary view of a bead area of the tire shown in FIG. 1; and

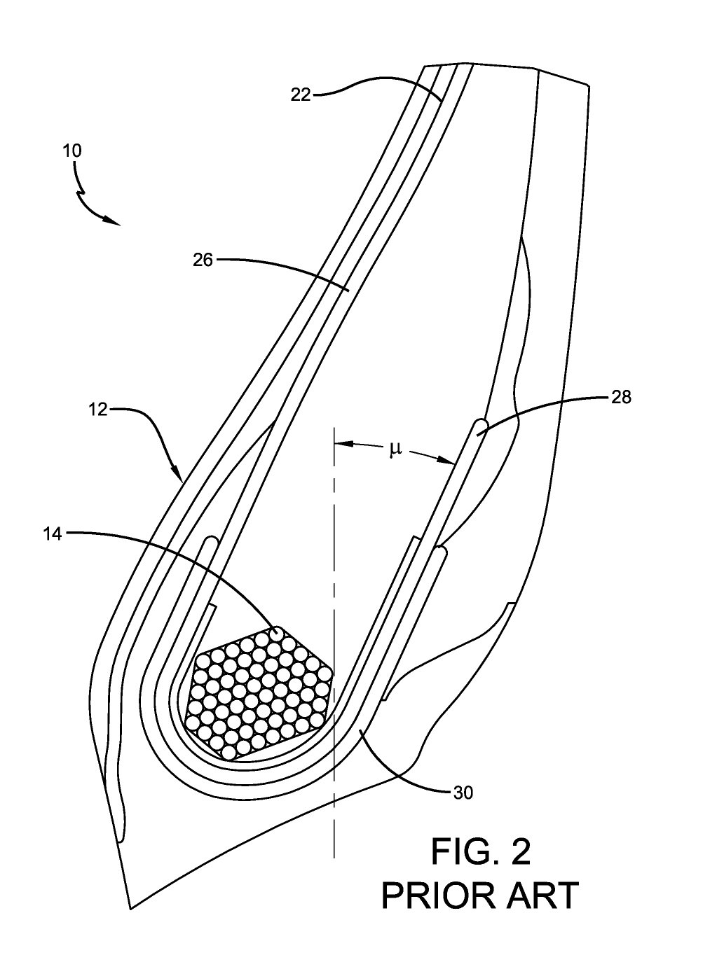

FIG. 3 is an enlarged fragmentary view of a bead area of an exemplary embodiment of the tire of the present invention.

Similar numerals refer to similar parts throughout the drawings.

### DETAILED DESCRIPTION OF THE INVENTION

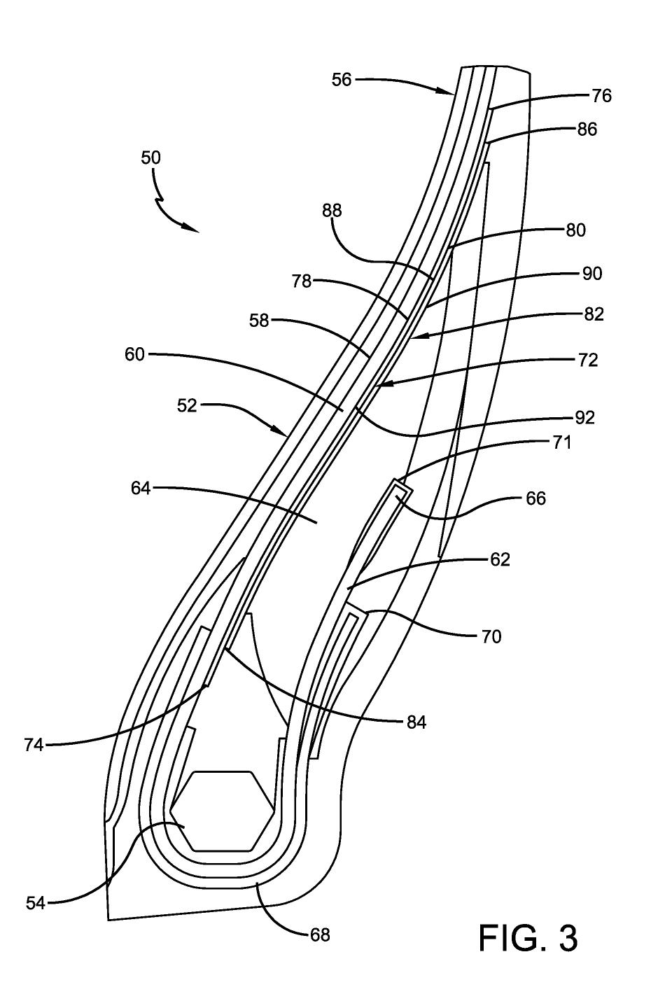

An exemplary embodiment of the tire of the present invention is shown in FIG. 3 and is indicated generally at 50. The general construction of the tire 50 is somewhat similar to that of prior art tire 10, with the principal differences to be described in detail below.

The tire 50 includes a pair of bead areas 52 (only one shown) and a respective bead core 54 embedded in each bead area. A carcass 56 includes at least one ply 58 that preferably winds around each bead core 54. A main portion 60 of the carcass reinforcing ply 58 extends radially inward toward the tire rim (not shown) and is turned about each bead core 54 to form a carcass ply turn up 62. The carcass reinforcing ply 58 is also wrapped about a bead apex 64. In this manner, the carcass reinforcing ply 58 envelopes the bead core 54 and a lower portion of the bead apex 64 in each bead area 52. The carcass ply turn up 62 terminates at a radially outward end 66 and may include an end cap 71. A chafer 68 is disposed about the radially inward surface of the carcass ply turn up 62 to resist chafing of the tire 50 by the rim, and may include an end cap 70.

Axially inward of the carcass ply turn up 62 is an axially inner chipper 72, which is a reinforced layer, as will be described in greater detail below. The axially inner chipper 72 includes a radially inward end 74, a radially outward end 76, an inboard surface 78 and an outboard surface 80. Axially outward of the axially inner chipper 72 is an axially outer chipper 82, which is a reinforced layer, as will be described in greater detail below. The axially outer chipper 82 includes a radially inward end 84, a radially outward end 86, an inboard surface 88 and an outboard surface 90.

The inboard surface 78 of the inner chipper 72 is bonded to an outboard surface 92 of the carcass ply main portion 60 radially outwardly of the bead core 14 and axially inwardly of the ply turn up 62. In this manner, the inner chipper 72 is bonded to the carcass ply main portion 60 on the internal or axially inner side of the bead apex 64. The inboard surface 88 of the outer chipper 82 is bonded to the outboard surface 80 of the inner chipper 72. In this manner, the outer chipper 82 is also bonded to the carcass ply main portion 60 on the internal or axially inner side of the bead apex 64, thereby forming a multi-layer structure on the internal side of the bead apex.

The radially inward end 74 of the inner chipper 72 is disposed radially outwardly of the bead core 54 and the inner chipper extends past the turn up outward end 66, so that the radially outward end 76 of the inner chipper is disposed radially outwardly of the outward end of the turn up 62. The radially inward end 84 of the outer chipper 82 is also disposed radially outwardly of the bead core 54 and the outer chipper extends past the turn up outward end 66, so that the radially outward end 86 of the outer chipper is disposed radially outwardly of the outward end of the turn up 62.

The outer chipper 82 preferably is of a shorter length than the inner chipper 72. The radially inward end 84 of the outer chipper 82 preferably is disposed radially outwardly of the radially inward end 74 of the inner chipper 72 by a distance of at least 5 millimeters (mm). Likewise, the radially outward end 86 of the outer chipper 82 preferably is disposed radially inwardly of the radially outward end 76 of the inner chipper 72 by a distance of at least 5 mm.

The inner chipper 72 is formed of an elastomer or polymer compound known to those skilled in the art. The outer chipper 82 may be formed of the same elastomer or polymer compound as the inner chipper 72, or of a different elastomer or polymer compound.

Both the inner chipper 72 and the outer chipper 82 are reinforced with substantially inextensible cords. Preferably the cords are made of steel having a mesh of parallel cords between about 8 and 18 ends per inch, and more preferably between about 12 and 16 ends per inch. The wire cord gauge of each chipper 72 and 82 is preferably between about 0.6 mm and 1.5 mm. Alternatively, the cords in each chipper 72 and 82 may be made of a polyamide monofilament cord of any cross-sectional shape, such as round, oval or star. The cords of each chipper 72 and 82 preferably are oriented at an angle of between about 25 degrees and about 85 degrees with respect to the radially oriented steel cords that reinforce the carcass ply 58. More preferably, the cords of each chipper 72 and 82 are oriented between about 25 and about 45 degrees.

The inner chipper 72 and the outer chipper 82, when assembled as shown, preferably have generally equal, but oppositely oriented cord angles. Employing both chippers 72 and 82 and having their cord angles biased oppositely at the locations where they are joined limits the bending of the bead area 52. Such limitation of the bending of the bead area 52 in turn limits or lowers the forces that act on the carcass ply turn up 62.

In this manner, the tire 50 of the present invention provides a structure in which forces due to deflection in the bead area 52 are limited by the inner chipper 72 and the outer chipper 82. Such limitation of forces by the outer chipper 72 and the inner chipper 82 lowers shear stresses along the carcass ply turn up 62. Lowering or reducing the stresses in the carcass ply turn up 62 enables the tire 50 to resist fatigue cracking in the bead area 52, thereby improving the durability of the bead area.

The pneumatic radial tire of the invention 50 thus includes a layered chipper structure 72, 82 axially inwardly of the bead apex 64 that improves the durability of the respective bead areas 52 of the tire and the life of the tire. In the tire of the present invention 50, an advantage includes increased bead durability under heavy loads or high heat conditions, as is seen in commercial vehicles such as buses, tractors and medium commercial truck tires designed for heavy loads. Such tires 50 typically have large rim diameters of about 20 inches (508 mm) or greater, and are designed to be retreaded such that the bead portions of the carcass 20 may be exposed to many hundreds of thousand miles. The ability to provide a more durable bead portion or area 52 as accomplished by the tire of the present invention 50 thereby also provides a longer-lasting tire carcass 20.

The present invention also includes a method of forming a tire 50 with improved durability of the bead area 52. The method includes steps in accordance with the description that is presented above and shown in FIG. 3.

It is to be understood that the structure of the above-described tire 50 may be altered or rearranged, or components or steps known to those skilled in the art omitted or added, without affecting the overall concept or operation of the invention. For example, the teachings herein are applicable to a broad range of tires and may be useful in tire lines such as, but not limited to, passenger tires, radial medium truck tires, aircraft tires, and off-the-road tires, run-flat tires, and the like. Moreover, the invention applies to tires formed with any type of belt structure or tread configuration.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A pneumatic radial tire, the tire comprising:
a pair of opposing bead areas, wherein each bead area includes a bead core and a bead apex;
at least one carcass reinforcing ply, the reinforcing ply including a turn up at each bead core, each turn up including a radially outward end;
a pair of chippers disposed axially inwardly of each turn up outward end, the pair of chippers including a first chipper and a second chipper;
the first chipper being disposed axially inwardly of the bead apex;
the second chipper being disposed axially outwardly of the first chipper and axially inwardly of the bead apex, whereby forces due to deflection of the tire are limited by the pair of chippers to reduce stresses along each turn up.

2. The pneumatic radial tire of claim 1, wherein an inboard surface of the first chipper is bonded to an outboard surface of a main portion of the carcass reinforcing ply.

3. The pneumatic radial tire of claim 2, wherein an inboard surface of the second chipper is bonded to an outboard surface of the first chipper.

4. The pneumatic radial tire of claim 1, wherein a radially inward end of the first chipper is disposed radially outwardly of the bead core and the first chipper extends past the turn up radially outward end.

5. The pneumatic radial tire of claim 1, wherein a radially inward end of the second chipper is disposed radially outwardly of the bead core and the second chipper extends past the turn up radially outward end.

6. The pneumatic radial tire of claim 1, wherein the second chipper includes a length that is shorter than a length of the first chipper.

7. The pneumatic radial tire of claim 1, wherein a radially inward end of the second chipper is disposed radially outwardly of a radially inward end of the first chipper by a distance of at least 5 millimeters.

8. The pneumatic radial tire of claim 1, wherein a radially outward end of the second chipper is disposed radially inwardly of a radially outward end of the first chipper by a distance of at least 5 millimeters.

9. The pneumatic radial tire of claim 1, wherein the first and second chippers are reinforced with substantially inextensible cords.

10. The pneumatic radial tire of claim 9, wherein the substantially inextensible cords include generally equal, but oppositely oriented cord angles.

11. The pneumatic radial tire of claim 1, wherein the tire is a commercial truck tire that includes a nominal bead diameter of at least about 20 inches.
